(19) United States
(12) Patent Application Publication
(10) Pub. No.: US 2025/0302226 A1
(43) Pub. Date: Oct. 2, 2025

(54) 2-in-1 AIR FRYER AND SLOW COOKER

(71) Applicant: Hamilton Beach Brands, Inc., Glen Allen, VA (US)

(72) Inventors: Drew Carlson, Glen Allen, VA (US); Derek McCullough, Glen Allen, VA (US); Chad Majewski, Glen Allen, VA (US)

(73) Assignee: Hamilton Beach Brands, Inc., Glen Allen, VA (US)

(21) Appl. No.: 18/621,978

(22) Filed: Mar. 29, 2024

(51) Int. Cl. A47J 27/00; A47J 37/06

(52) U.S. Cl. CPC A47J 27/004; A47J 37/0641

(57) ABSTRACT

A cooking appliance includes: a housing; an inner liner positioned within the housing, the inner liner defining a vessel cavity; a motor mounted in the housing, the motor attached to a first fan positioned within the vessel cavity; a heating element mounted within the vessel cavity; and a controller operatively connected with the motor and the heating element. The controller is configured such that, in a first cooking mode, the heating element is activated but the motor is deactivated, and in a second cooking mode the heating element is activated and the motor is activated so that the fan rotates within the inner liner.

### FIELD OF THE INVENTION

The present invention relates generally to a kitchen appliance, and more particularly to slow cookers configured with components for air-based frying of foodstuffs.

### BACKGROUND

Kitchen appliances with specialized cooking modes are becoming more popular. For example, both air-based fryers and slow cookers for the home are well-known. Slow cookers typically include a vessel that holds food to be cooked therein and one or more heating elements that heat the vessel (and therefore the food). Slow cookers include a lid that is not sealed to the remainder of the housing to permit some air flow. Air fryers typically include a basket that fits within a housing that holds the food to be cooked. A fan (typically located in the lower portion of the housing or the lid) circulates air past a heating element and into the basket to “air-fry” the food in the basket.

As additional types of kitchen appliances are becoming available in the marketplace, consumers are finding that they are running out of cabinet space within their homes to store all of these appliances. Thus, it may be desirable to combine multiple cooking functions in a single appliance.

### SUMMARY

As a first aspect, embodiments of the invention are directed to a cooking appliance comprising: a housing; an inner liner positioned within the housing, the inner liner defining a vessel cavity; a motor mounted in the housing, the motor attached to a first fan positioned within the vessel cavity; a heating element mounted within the vessel cavity; and a controller operatively connected with the motor and the heating element, the controller being configured such that, in a first cooking mode, the heating element is activated but the motor is deactivated, and in a second cooking mode the heating element is activated and the motor is activated so that the fan rotates within the inner liner.

As a second aspect, embodiments of the invention are directed to a cooking appliance comprising: a housing; an inner liner positioned within the housing, the inner liner having a generally cylindrical side wall and defining a vessel cavity; a motor mounted in the housing, the motor attached to a first fan; a heating element mounted within the vessel cavity adjacent the side wall, the heating element configured to surround a cooking vessel positioned in the vessel cavity; and a controller operatively connected with the motor and the heating element, the controller being configured such that, in a first cooking mode, the heating element is activated but the motor is deactivated, and in a second cooking mode the heating element is activated and the motor is activated so that the fan rotates to circulate air within the inner liner.

As a third aspect, embodiments of the invention are directed to a vessel for air frying comprising: a floor; a generally cylindrical side wall that extends upwardly from the floor; a perforated food rack mounted to an inner surface of the side wall above the floor; and a drip pan positioned between the floor and the food rack.

### BRIEF DESCRIPTION OF THE FIGURES

FIG. 1 is a top perspective view of a cooking appliance according to embodiments of the invention.

FIG. 2 is a Top perspective view of the cooking appliance of FIG. 1 with the lid removed.

FIG. 3 is a perspective section view of the cooking appliance of FIG. 1.

FIG. 4 is an enlarged partial side section view of the cooking appliance of FIG. 1.

FIG. 5 is an enlarged partial cross-section of a duct extending between the inner liner and the housing of the appliance of FIG. 1.

FIG. 6 is a top perspective view of the slow cooking vessel of the cooking appliance of FIG. 1.

FIG. 7 is a perspective section view of the cooking appliance of FIG. 1 with the slow cooking vessel of FIG. 6 in place.

FIG. 8 is a greatly enlarged partial section view of the lip of the slow cooking vessel of FIG. 5 resting on the upper edge of the inner liner of the cooking appliance of FIG. 1.

FIG. 9 is a greatly enlarged partial section view as in FIG. 8 with the lid in place.

FIG. 10 Is a top perspective view of the air fryer basket of the cooking appliance of FIG. 1.

FIG. 11 is a perspective section view of the air fryer basket of FIG. 10.

FIG. 12 is a perspective section view of the cooking appliance of FIG. 1 with the air fryer basket of FIG. 10 in place for air frying.

FIG. 13 is a greatly enlarged perspective section view of a latch used to mount the food rack and the drip tray to the side wall of the air fryer basket of the cooking appliance of FIG. 1.

FIG. 14 is an enlarged partial section view of the air fryer basket of the cooking appliance of FIG. 1 resting on the fan shield when the air fryer basket is in place for cooking.

FIG. 15 Is a section view of the cooking appliance of FIG. 1 with both the slow cooking vessel and the air fryer basket in position for storage.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the figures, certain layers, components or features may be exaggerated for clarity, and broken lines illustrate optional features or operations unless specified otherwise.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

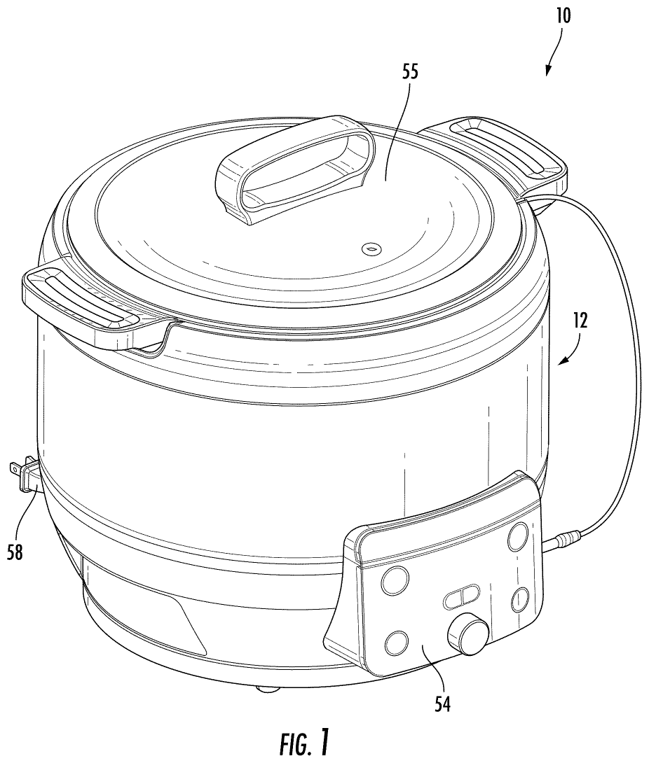

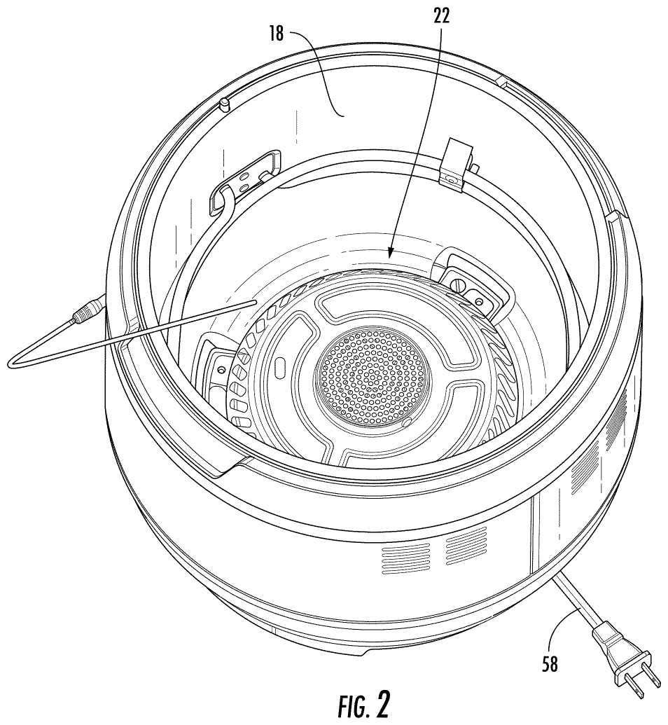

Referring now to the figures, a dual slow-cooking, air-frying appliance is shown therein and designated broadly at 10. Referring to FIGS. 1-3, the appliance 10 includes an overall housing 12 that is generally cylindrical, with a generally horizontal floor 14 supporting a side wall 16. An inner liner 18 is present within the housing 12. The inner liner 18 has a floor 20 that is positioned above the floor 14 of the housing 12, and further includes a cylindrical side wall 21 that is positioned radially inwardly from the side wall 16. A duct 23 extends between an opening 21a in the side wall 21 of the inner liner 18 and vents 16a in the side wall 16 the side wall 16 of the housing 12 (see FIG. 5).

A frustoconical fan guard 22 is mounted centrally on the floor 20 and rises slightly upwardly therefrom. A short air inlet 25 with small vent holes 26 rises from the upper surface 24 of the fan guard 22. An inclined surface 28 extends between the floor 20 and the upper surface 24. Vents 30 are present in the inclined surface 28.

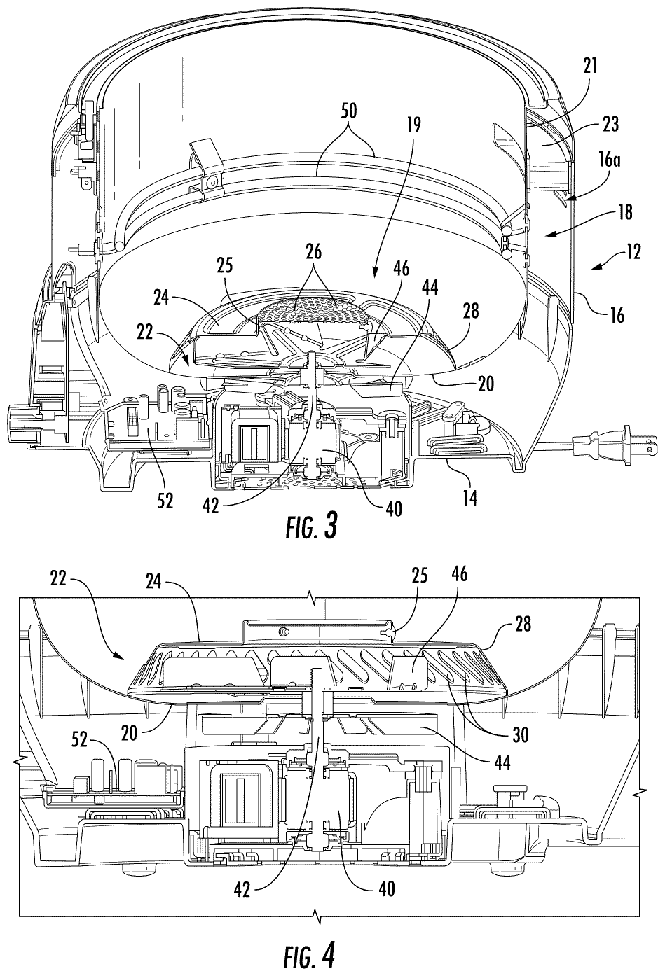

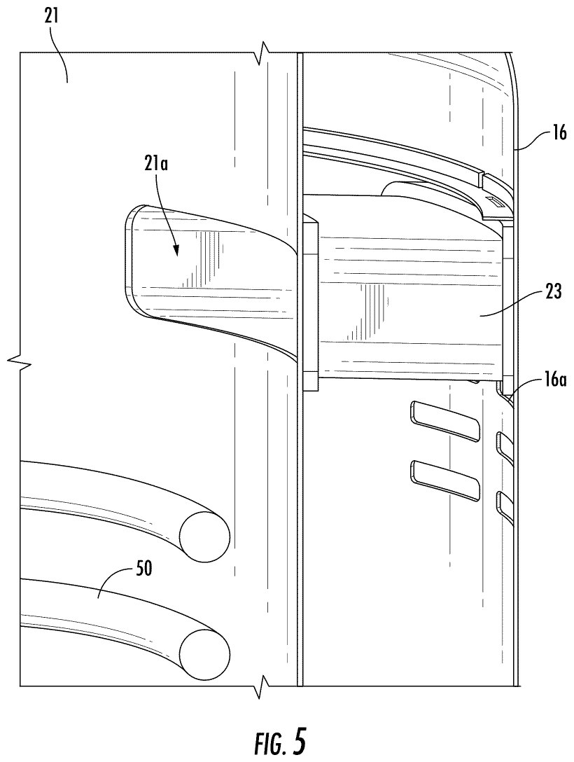

As can be seen in FIGS. 3 and 4, a motor 40 is mounted on the floor 14 of the housing 12. A shaft 42 extends upwardly from the motor 40. A lower fan 44 is mounted to the shaft 42 below the floor 20 of the inner liner 18. An upper fan 46 is mounted to the shaft 42 above the level of the floor 20, but below the upper surface 24 of the fan guard 22.

As seen in FIGS. 3 and 5, the appliance 10 includes one or more heating elements 50. The heating elements 50 define a generally circular route just radially inwardly of the side wall 21 of the inner liner 18. The heating elements 50 are operatively connected with a PCB 52 mounted on the floor 14 that serves as a controller for the appliance 10. The PCB 52 is also operatively connected with the motor 40 and with a control panel 54 that is mounted on an external surface of the side wall 16 of the housing 12 (see FIG. 1). A power cord 58 is operatively connected with the motor 40, the heating elements 50, and the PCB 52.

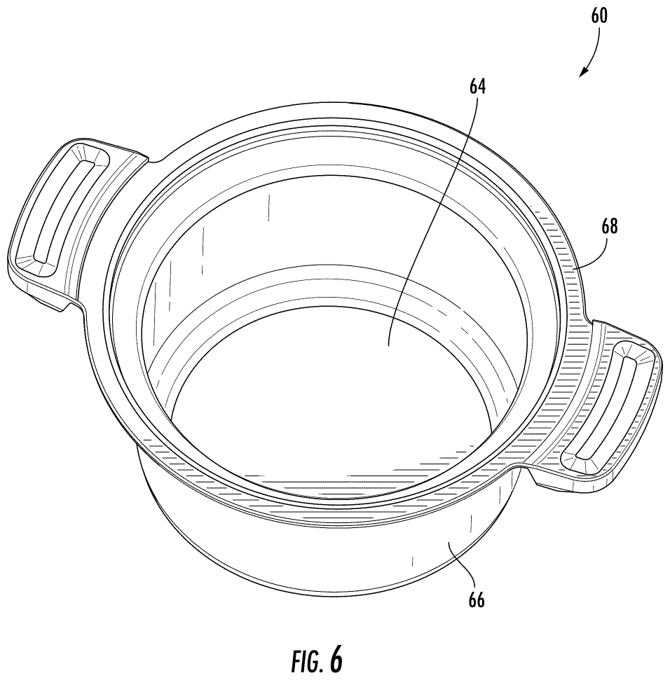

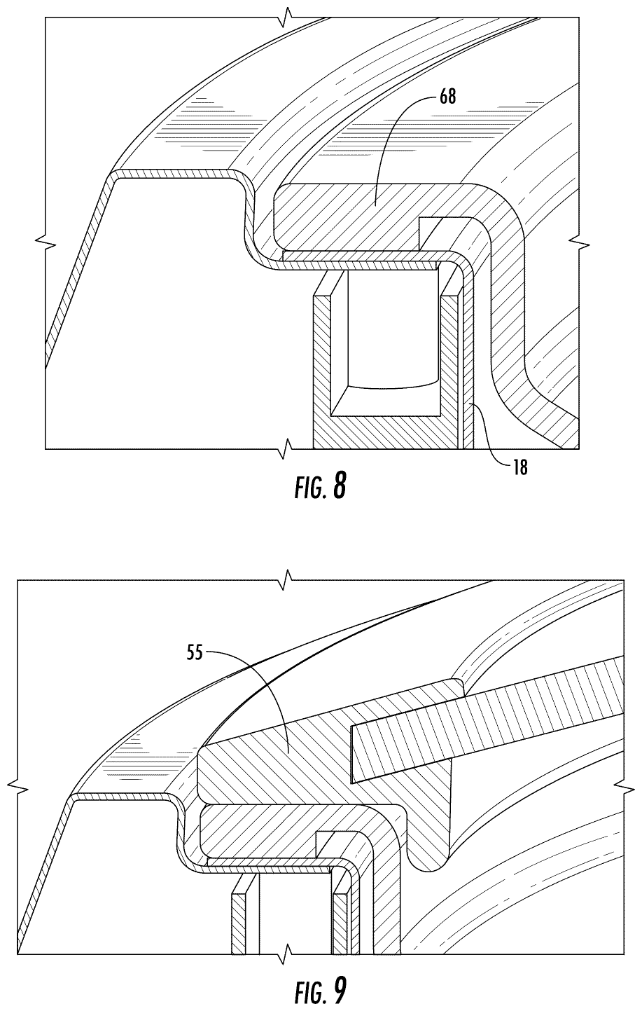

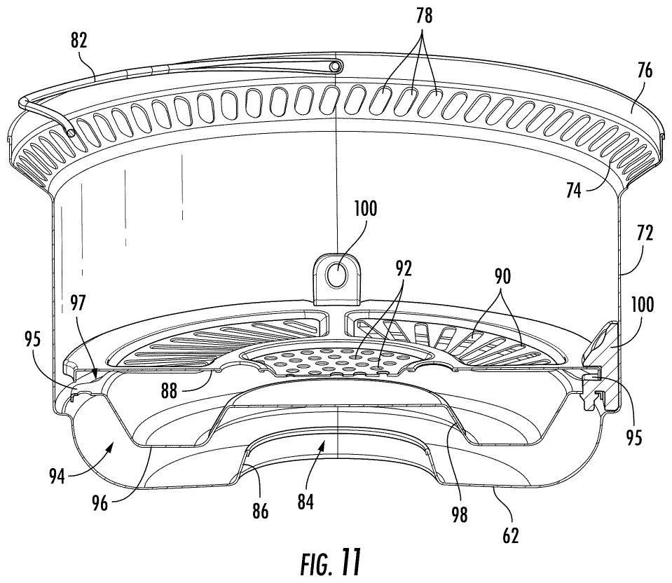

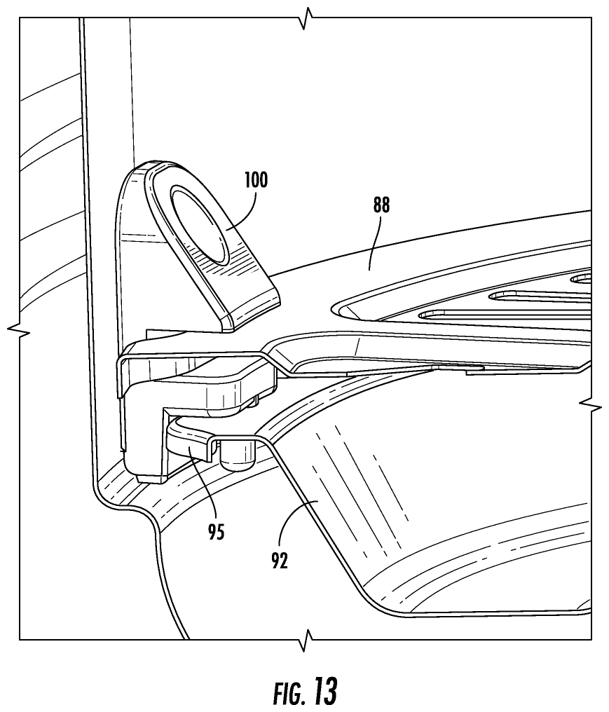

The inner liner 18 defines a vessel cavity 19 that can receive either a slow cooker vessel 60 (see FIGS. 6-9) or an air-fryer basket 62 (see FIGS. 10-14). Each of these is described in greater detail below along with its use in cooking.

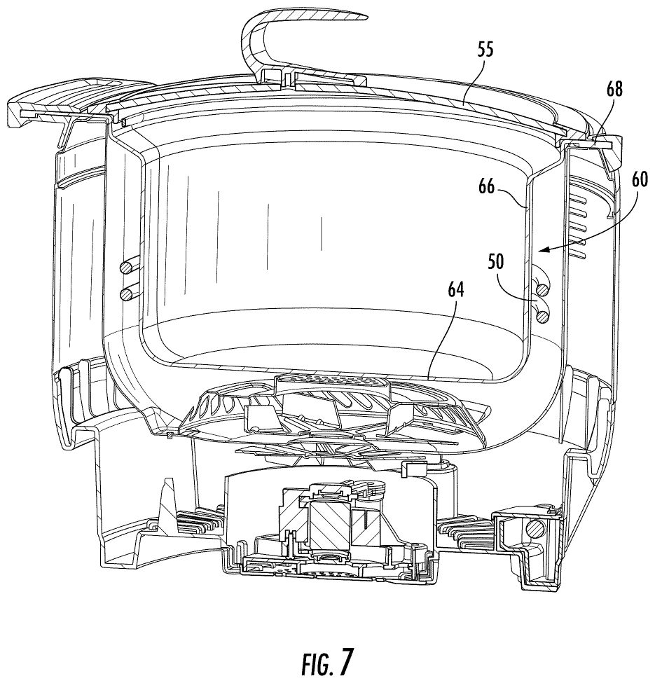

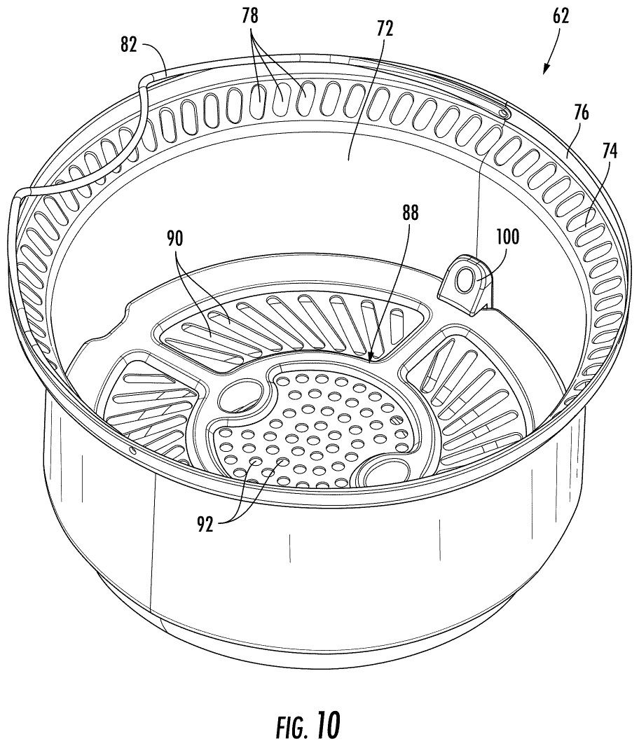

Referring now to FIGS. 6-9, the slow cooker vessel 60 is generally bowl-shaped, with a floor 64 and a cylindrical side wall 66. A lip 68 extends outwardly from the upper edge of the side wall 66. As can be seen in FIGS. 7-9, in use the slow cooker vessel 60 is received within the inner liner 18, and is encircled by the heating elements 50. The lip 68 rests on the upper edge of the side wall 21 of the inner liner 18. As shown in FIGS. 7 and 9, a lid 55 is then placed on the lip 68 to cover the slow cooker vessel 60 as food is cooked therein.

Once the slow cooker vessel 60 is placed within the inner liner 18 as discussed above, food is placed in the slow cooker vessel 60, and the lid 55 is positioned as described, the appliance 10 can be operated in a slow cooking mode. With the control panel 54, the user selects cooking parameters (e.g., slow cooking mode, temperature, time, etc.) and activates the appliance 10. The controller 52 signals the heating elements 50 to heat up, and may be configured to monitor the temperature and to activate/deactivate the heating elements 50 to maintain the desired temperature. In the slow cooking mode, the motor 40, and therefore the lower and upper fans 44, 46, do not operate.

Once slow cooking is completed, the slow cooking vessel 60 can be removed from the inner liner 18 for cleaning.

Referring now to FIGS. 10-14, the air fryer basket 62 (also referred to herein as a vessel) is generally bowl-shaped, with a floor 70 and a side wall 72. A lip 74 extends upwardly and radially outwardly of the upper edge of the side wall 72; a rim 76 extends upwardly from the lip 74. Oblong vents 78 are present throughout the lip 74. A handle 82 is pivotally attached to the rim 76 to facilitate insertion and removal of the air fryer basket 62 from the inner liner 18. A sloping wall 86 rises from the radially inward portion of the floor 70 and defines a central opening 84.

A perforated food rack 88 extends horizontally between lower sections of the side wall 72. The food rack 88 includes both elongated openings 90 and circular openings 92, with the circular openings 92 being located in the central portion of the food rack 88 and the elongated openings 90 being located radially outwardly of the circular openings 92. A drip pan 94 is positioned below the food rack 88. The drip pan 94 includes an annular trough 96 that surrounds a central tower 98. The drip pan 94 also includes four tabs 95 that are circumferentially equidistant from each other that extend radially outwardly from the outer edge of the trough 96. Both the food rack 88 and the drip pan 94 are held to the side wall 72 of the air fryer basket 62 via four latches 100. When the food rack 88 and the drip pan 94 are removed from the air fryer basket 62, the four latches 100 can deflect to allow the food rack 88 to be separated from the drip pan 94 for cleaning. The four latches 100 are fixed to the four tabs 95 of the drip pan 94. Although the food rack 88 extends to almost reach the side wall 72, the presence of the tabs 95 of the drip pan 94 positions the outer edge of the drip pan 94 so that a gap 97 is present between the outer edge of the drip pan 94 and the side wall 72.

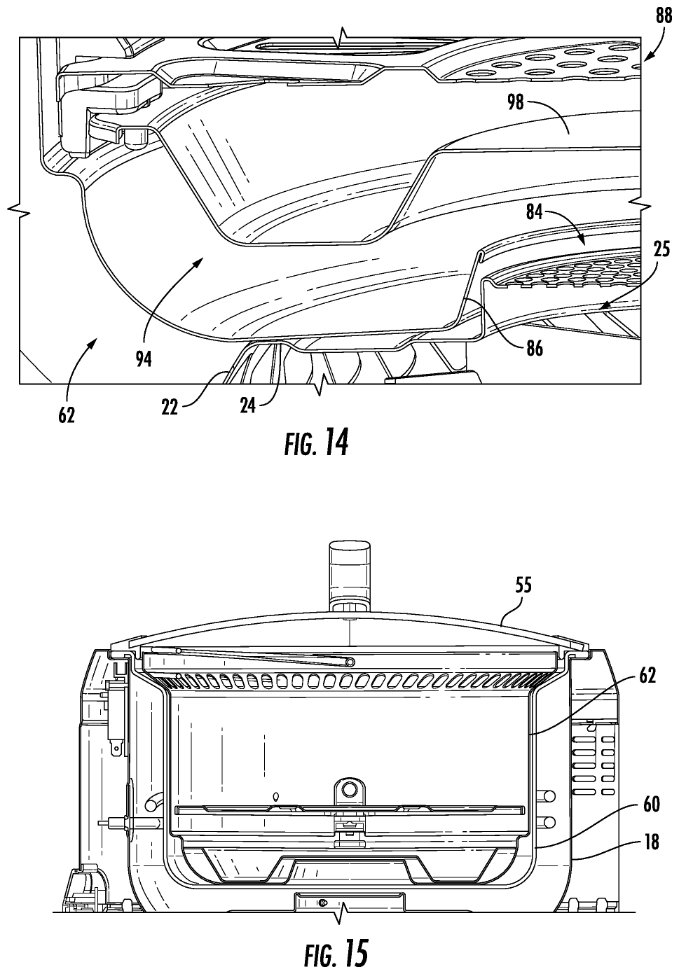

In use, as shown in FIG. 14, the air fryer basket 62 rests on the upper surface 24 of the fan guard 22 of the inner liner 18, with the heating elements 50 encircling the side wall 72. The tower 98 overlies and encircles the central opening 84 and the air inlet 25. An air gap 102 is present between the rim 76 of the air fryer basket 62 and the inner liner 18. The aforementioned lid 55 is placed on the upper edge of the inner liner 18 as food is cooked therein.

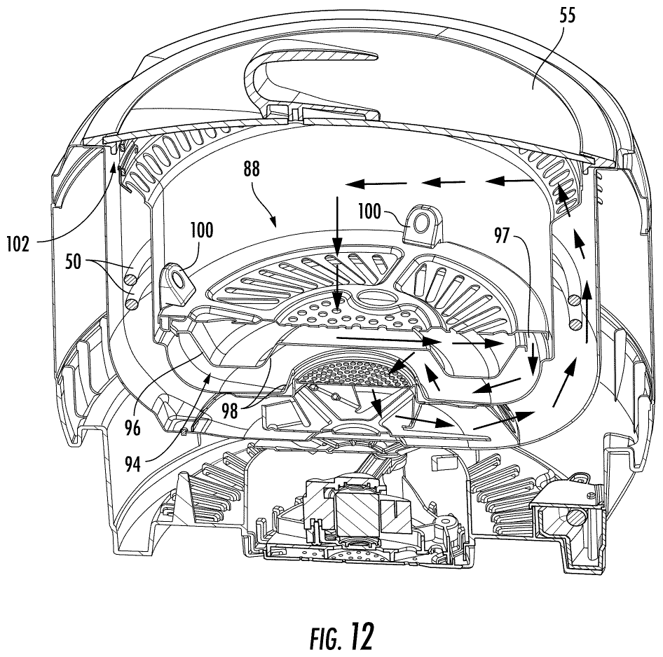

Once the air fryer basket 62 is placed within the inner liner 18 as discussed above, food is placed in the air fryer basket 62, and the lid 55 is positioned as described above, the appliance 10 can be operated in an air frying mode. With the control panel 54, the user selects cooking parameters (e.g., air frying mode, temperature, time, etc.) and activates the appliance 10. The controller 52 signals the heating elements 50 to heat up, and also activates the motor 40, which rotates the lower and upper fans 44, 46. The lower fan 44 draws cool air up from below the floor 14 and circulates the air through the housing 12 and out of the housing vents 16a to cool the motor 44 and the housing 12. The upper fan 46 is configured to draw air downwardly through elongated openings 90 and the circular openings 88 in the food rack 88, through the gap 97 between the drip pan 94 and the side wall 72, through the vent holes 26 in the fan guard 22, radially outwardly along the floor 20 of the inner liner 18, upwardly between the side wall 21 of the inner liner 18 and the side wall 72 of the air fryer basket 62, through the vents 78, and back downwardly toward the lower portion of the air fryer basket 62 (this path is indicated by arrows in FIG. 12). The air is heated as it passes the heating elements 50 between the inner liner 18 and the air fryer basket 62, and therefore can heat the food in the air fryer basket 62 on its downward path within the air fryer basket 62.

Notably, the path followed by the circulating air can help direct debris, oil droplets, and the like away from the lower fan 44 and motor 40, as the meandering and somewhat “tortuous” path can help to catch such debris, etc. in the trough in the drip pan 92. This can help to prevent such debris from exiting the air fryer basket 62, keeping the inner liner 18 clean, and from reaching the motor 40 and clogging it or otherwise impacting its performance.

Once air frying is completed, the air fryer basket 62 can be removed from the inner liner 18 for cleaning. The food rack 88 and the drip pan 94 can both be removed from the remainder of the air fryer basket 62 to facilitate cleaning.

FIG. 15 illustrates a storage mode for the appliance 10. As can be seen in FIG. 15, the air fryer basket 62 can fit within the slow cooking vessel 60. Both vessels 60, 62 can then fit within the inner liner 18, and that lid 55 can be positioned on the lip of the slow cooking vessel 60 as described above. In this manner, all of the components of the appliance can be stored in a compact unit.

Those of skill in this art will appreciate that other configurations are also possible. For example, more or fewer heating elements may be employed, and/or the heating elements may be located differently (e.g., higher or lower relative to the inner liner). The slow cooker vessel may be configured so that its upper edges are located inside, rather than atop, the inner liner during cooking. Conversely, the air fryer basket may rest atop the inner liner during cooking rather than being supported by the fan shield. In some embodiments the air fryer basket and the slow cooker vessel may be configured so that they are not both stored together in the inner liner during storage. The number, shape, and pattern of openings in the air fryer basket may differ from that shown. Other variations may also be employed.

In addition, the controller may be configured in different ways. For example, the controller may be programmable, such that it initiates cooking only after a predetermined delay or at a particular time, or such that it discontinues cooking after a set period. The controller may also be configured to communicate with a remote device (via Wifi, Bluetooth, or the like), which can provide the user with the ability to activate the appliance from a remote location (e.g., the ingredients may be placed in the appliance in slow cooking mode, then activated remotely by a user to ensure that cooking is completed upon the user's arrival at home).

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention.

That which is claimed is:

1. A cooking appliance, comprising:
a housing;
an inner liner positioned within the housing, the inner liner defining a vessel cavity;
a motor mounted in the housing, the motor attached to a first fan positioned within the vessel cavity;
a heating element mounted within the vessel cavity; and
a controller operatively connected with the motor and the heating element, the controller being configured such that, in a first cooking mode, the heating element is activated but the motor is deactivated, and in a second cooking mode the heating element is activated and the motor is activated so that the fan rotates within the inner liner.

2. The cooking appliance defined in claim 1, further comprising a first cooking vessel positioned in the vessel cavity, the first cooking vessel configured to be used with the first cooking mode, wherein the first cooking vessel is positioned so that the heating element is located between the first cooking vessel and the inner liner.

3. The cooking appliance defined in claim 1, further comprising a second cooking vessel positioned in the vessel cavity, the second cooking vessel configured to be used with the second cooking mode, wherein the second cooking vessel is positioned so that the heating element is located between the second cooking vessel and the inner liner.

4. The cooking appliance defined in claim 3, wherein the second cooking vessel includes a floor and a perforated food rack positioned above the floor.

5. The cooking appliance defined in claim 4, further comprising a drip pan positioned between the food rack and the floor.

6. The cooking appliance defined in claim 4, wherein the floor includes at least one opening to provide fluid communication between the vessel cavity and an air fryer cavity defined by the second cooking vessel.

7. The cooking appliance defined in claim 1, wherein a fan guard is mounted to the inner liner and overlies the first fan.

8. The cooking appliance defined in claim 7, wherein the fan guard includes an air inlet positioned to draw air from the vessel cavity to the first fan and at least one outlet aperture positioned to permit air to be forced back into the vessel cavity.

9. The cooking appliance defined in claim 1, wherein the heating element is generally circular and is positioned adjacent a side wall of the inner liner.

10. The cooking appliance defined in claim 1, further comprising a lid that covers the vessel cavity, the lid configured for use with the first cooking mode and the second cooking mode.

11. The cooking appliance defined in claim 10, wherein the appliance may take a storage mode in which a first vessel configured for slow cooking and a second vessel configured for air frying are both positioned within the vessel cavity as the lid covers the vessel cavity.

12. A cooking appliance, comprising:
a housing;
an inner liner positioned within the housing, the inner liner having a generally cylindrical side wall and defining a vessel cavity;
a motor mounted in the housing, the motor attached to a first fan;
a heating element mounted within the vessel cavity adjacent the side wall, the heating element configured to surround a cooking vessel positioned in the vessel cavity; and
a controller operatively connected with the motor and the heating element, the controller being configured such that, in a first cooking mode, the heating element is activated but the motor is deactivated, and in a second cooking mode the heating element is activated and the motor is activated so that the fan rotates to circulate air within the inner liner.

13. A vessel for air frying, comprising:
a floor;
a generally cylindrical side wall that extends upwardly from the floor;
a perforated food rack mounted to an inner surface of the side wall above the floor; and
a drip pan positioned between the floor and the food rack.

14. The vessel defined in claim 13, further comprising an air inlet rising from the floor, the air inlet including one or more openings.

15. The vessel defined in claim 14, wherein the drip tray includes a central tower, the central tower being located directly above the air inlet.

16. The vessel defined in claim 15, wherein a trough encircles the central tower.

17. The vessel defined in claim 15, wherein the central tower includes an upper surface that is devoid of openings.

18. The vessel defined in claim 13, wherein the drip tray is mounted to the inner surface of the side wall so that a gap is present therebetween.

19. The vessel defined in claim 13, further comprising a lip extending from an upper edge of the side wall, the lip including a plurality of openings.

20. The vessel defined in claim 19, wherein the lip extends radially outwardly from the side wall.
